(19) United States
(12) Patent Application Publication
(10) Pub. No.: US 2010/0012744 A1
(43) Pub. Date: Jan. 21, 2010

(54) MULTI-ZONE SPRINKLER SYSTEM WITH MOISTURE SENSORS AND ADJUSTABLE SPRAY PATTERN

(76) Inventor: Lawrence Kates, Corona Del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/174,548

(22) Filed: Jul. 16, 2008

(51) Int. Cl. B05B 12/08; B05B 17/04

(52) U.S. Cl. 239/11; 239/63

(57) ABSTRACT

An irrigation system comprises sprinkler heads with an electrically adjustable spray pattern, moisture sensors, and a controller. Based upon input signals from the moisture sensors, the controller dynamically configures the spray pattern of the sprinkler head to allow more water to fall on areas that need to be watered and less water to fall on areas that do not require additional water.

### BACKGROUND OF THE INVENTION

1. Field of the Invention

The invention relates generally to landscape sprinkler systems and more particularly to landscape sprinkling systems and methods having a computer configured spray pattern.

2. Description of the Related Art

In the past, it has been a well-known practice to provide automatic watering devices, such as sprinklers, in order to supply plants with a proper amount of moisture so that the plants will flourish. Homeowners and commercial establishments, such as golf courses, recreational parks, and farms, use automatic watering systems.

A conventional system employs a timer controller, which operates a solenoid valve incorporated into a water system so that when the time as arbitrarily set by the user arrives, power is supplied via the solenoid to the water supply valve so that water is then supplied to a system of sprinklers or other irrigation devices. However, the sprinkler system supplies water even though the ground or plant medium is saturated such as after a heavy rain or the like.

For example, an area or zone requiring irrigation may contain thin sandy soil with low water holding capacity from which water drains easily. Another zone may contain a deeper sand, clay and silt mixture, which drains slowly and holds water for a longer period. If the irrigator applies water uniformly at a rate equal to the average required over the area, the user is faced with the dilemma of having too little water in one zone and too much in the other. In practice, the user typically irrigates the entire area at the rate required for the most deficient soil, which wastes water in the zones, which do not require additional water. As the cost of water increases, this creates an unnecessary expense for the user.

### SUMMARY OF THE INVENTION

In one embodiment, a sprinkler head configured to water a zone including first and second portions is disclosed, wherein the sprinkler head includes an adjustable spray pattern, and wherein the first portion of the area corresponds to a first distance, and wherein the second portion of the area corresponds to a second distance. A first moisture sensor is provided at the first distance, wherein the first moisture sensor is configured to collect a first moisture data; and a second moisture sensor provided at the second distance, and wherein the second moisture sensor is configured to collect a second moisture data. Also provided is a controller configured to obtain the moisture data and control the adjustable spray pattern based on the first moisture data and the second moisture data. The controller controls the adjustable spray pattern such that water is applied in the first portion of the zone if the first moisture data indicates that the first portion of the zone needs water. The controller controls the adjustable spray pattern such that water is applied in the second portion of the zone if the second moisture data indicates that the second portion of the zone needs water.

In one embodiment, a method includes obtaining moisture data from a first moisture sensor associated with a rotating sprinkler head; obtaining moisture data from a second moisture sensor associated with a rotating sprinkler head; and automatically configuring an adjustable spray pattern based on the moisture data. Automatically configuring the adjustable spray pattern includes watering a first portion of the zone if the moisture data indicates the first portion of the zone to be less moist, and watering a second portion of the zone if the moisture data indicates the second portion of the zone to be less moist. The first portion of the zone corresponds to a radial distance substantially apart from the second portion of the zone.

In one embodiment, a sprinkler system obtains moisture data from a first moisture sensor associated with a rotating sprinkler head; obtains moisture data from a second moisture sensor associated with a rotating sprinkler head; and automatically configures an adjustable spray pattern based on the moisture data. The adjustable spray pattern includes watering a first portion of the zone if the moisture data indicates the first portion of the zone to be less moist, and watering a second portion of the zone if the moisture data indicates the second portion of the zone to be less moist. The first portion of the zone is located at a different distance from the second portion of the zone.

In one embodiment, the sprinkler system includes a rotating sprinkler head including an adjustable spray pattern; a zone to be watered by the rotating sprinkler head, the zone at least including a first region and a second region, wherein the first area and the second area are located at a different distances from the sprinkler head; one or more moisture sensors provided in the zone, wherein the one or more moisture sensors are configured to collect moisture data; and a controller configured to obtain the moisture data and configure the adjustable spray pattern based on the moisture data. The controller adjusts the adjustable spray pattern to apply water to the first area and/or the second area of the zone as indicated by the one or more moisture sensors to need watering.

In one embodiment, the sprinkler system includes a sprinkler having a sprinkler head, a spreader plate and a nozzle; one or more moisture sensors that measure moisture in a zone to be watered by the sprinkler head, wherein the one or more moisture sensors are configured to provide moisture data related to the zone; and a controller configured to obtain the moisture data and control the distances in the zone where the sprinkler applies water. The controller adjusts one or more of the position of the sprinkler head, the position of the spreader plate, the position of the nozzle, or volume of water going through the sprinkler to control the distances in the zone where the sprinkler applies water.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 shows a multi-zone sprinkler system.

FIG. 2 is a schematic diagram of a multi-zone sprinkler system.

FIG. 3 shows an adjustable-pattern sprinkler head with associated moisture sensors.

FIG. 4 is a block diagram of a rotating sprinkler with controllable rotation rates.

FIG. 5 shows a rotating sprinkler with an actuator to control rotation speed.

FIG. 6 is a schematic diagram of a non-rotating sprinkler head with an adjustable spray pattern.

FIG. 7 shows a schematic diagram of one embodiment of a multi-zone sprinkler system.

FIG. 8 shows an adjustable-pattern sprinkler head with associated multi-level moisture sensors.

FIG. 9 is a block diagram of a rotating sprinkler with controllable rotation speed, water elevation angle, spreader plate position and/or water flow parameters.

FIG. 10A shows a rotating sprinkler having a water elevation angle actuator and a spreader plate position actuator.

FIG. 10B shows a rotating sprinkler with a water elevation angle actuator and a water flow actuator.

FIG. 11 is a schematic diagram of one embodiment of a non-rotating sprinkler head with an adjustable spray pattern.

FIG. 12 shows a multi-zone sprinkler system.

### DETAILED DESCRIPTION OF THE PREFERRED EMBODIMENT

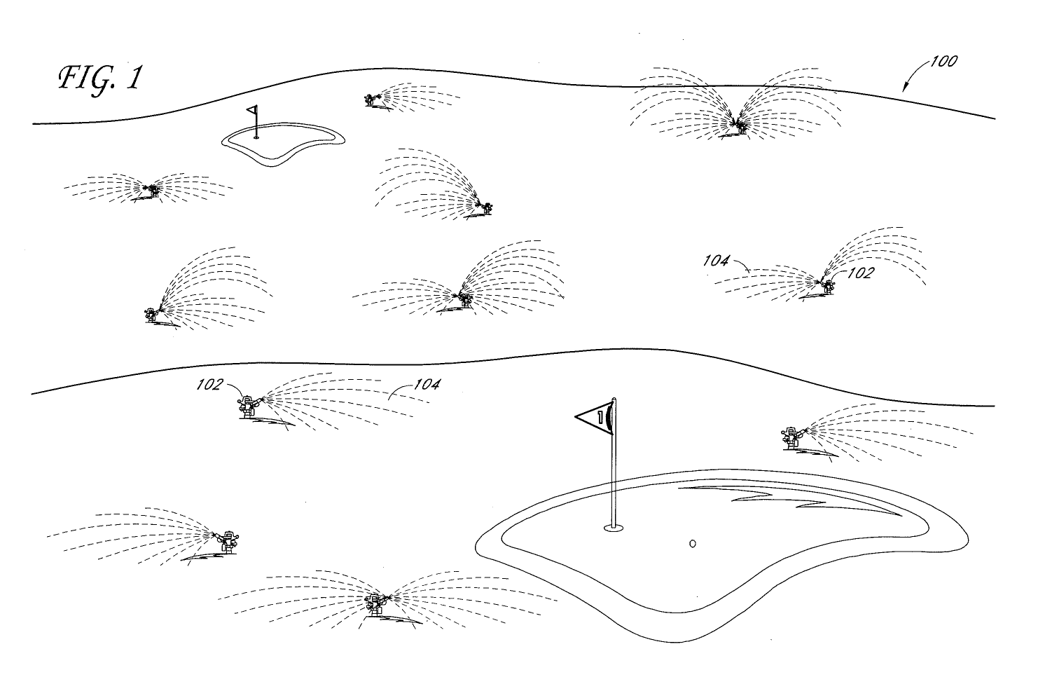

FIG. 1 illustrates a golf course as one exemplary application for one embodiment of a multi-zone sprinkler system 100. Other exemplary applications include, but are not limited to, recreational parks, home lawns, theme parks, cemeteries, farms, nurseries, and any other setting that provides water to vegetation through an automatic watering system. FIG. 1 illustrates one or more sprinklers 102, each having an adjustable spray pattern 104. In some embodiments, the adjustable spray pattern 104 is electrically controlled, such as, for example, using solenoids, step motors, and other devices capable of generating electric signals.

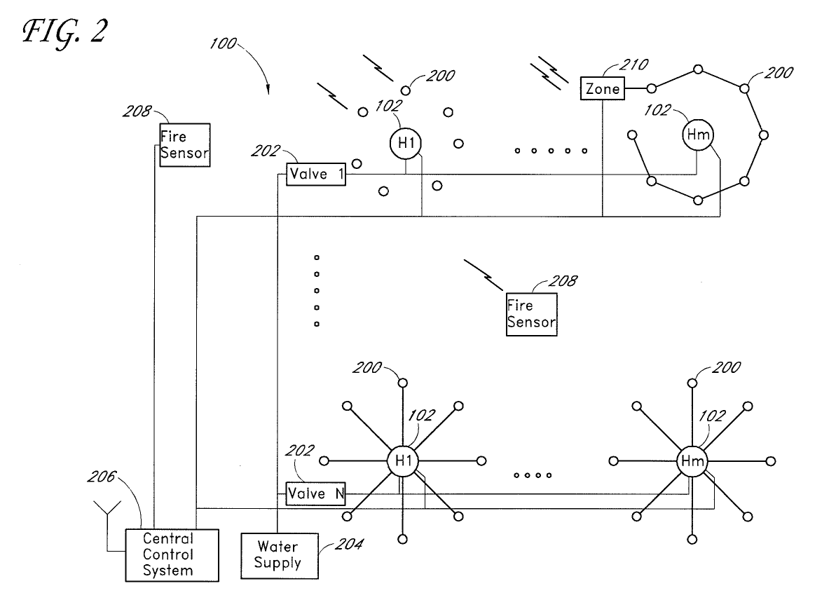

FIG. 2 is a schematic diagram of one embodiment of the multi-zone sprinkler system 100. The sprinkler system 100 includes the sprinklers 102, first level moisture sensors 200, water supply valves 202, a water supply 204, and a central control system 206.

In a typical arrangement, a series of water supply valves 202 each connect to the water supply 204. Each water supply valve 202 connects to a series of sprinklers 102, each sprinkler 102 having the adjustable spray pattern 104. When a switch or solenoid in the water supply valve 202 activates, the water from the water supply 204 flows through the water supply valve 202. Depending on the spray pattern 104 of the sprinkler 102, the sprinkler 102 waters some, all, or none of the area surrounding the sprinkler 102. In one embodiment, the sprinkler system 100 is arranged in watering zones.

In one embodiment, the water supply can include fertilizer, weed control solution, or any other soluble compound the user desires to apply to the area associated with the sprinkler system 100.

In other arrangements, the multi-zone sprinkler system 100 includes at least one water control valve 202, and at least one sprinkler 102 having an adjustable spray pattern 104.

The first level moisture sensors 200 are provided to sense the moisture in the soil. In one embodiment, the first level moisture sensors 200 form a circular or semi-circular arrangement around each sprinkler 102. The first level moisture sensors 200 provide data indicating the moisture content of the soil to the central control system 206. In one embodiment, the first level moisture sensors 200 provide data to the central control system via a radio frequency (RF) link, or other wireless transmission system.

In another embodiment, the first level moisture sensors 200 electrically connect to the sprinklers 102 and the sprinklers 102 communicate with the central control system 206 via the wireless transmission system. The first level moisture sensors 200 collect the moisture data and provide the moisture data through the electrical connection to the sprinklers 102. The sprinklers 102 provide the moisture data via the wireless transmission system, such as the RF link, to the central control system 206.

In another embodiment, the first level moisture sensors 200 electrically connect to the sprinklers 102 and the sprinklers 102 electrically connect to the central control system 206. The first level moisture sensors 200 collect the moisture data and provide the moisture data through the electrical connection to the sprinklers 102. The sprinklers 102 provide the moisture data through the electrical connection to the central control system 206.

In another embodiment, the multi-zone sprinkler system 100 further includes a zone controller 210. The first level moisture sensors 200 located in the zone controlled by the zone controller 210 provide the moisture data to the zone controller 210. The zone controller 210 provides the moisture data to the central control system 206.

In one embodiment, the moisture sensors 102 provide the moisture data via a wireless transmission system, such as, for example, the RF link, to the zone controller 210. In another embodiment, the first level moisture sensors 200 electrically connect to the zone controller 210. Each moisture sensor 200 can be individually wired to the zone controller 210, or groups of first level moisture sensors 200 can be wired in a consecutive pattern, i.e., daisy chained, and the last moisture sensor 200 in the chain electrically connects to the zone controller 210. The first level moisture sensors 200 provide the moisture data to the zone controller 210 through the electrical connection.

In one embodiment, the zone controller 210 communicates with the central control system via the wireless transmission system, such as, for example, the RF link, and provides the moisture data via the wireless transmission system to the central control system 206. In another embodiment, the zone controller 210 electrically connects to the central control system 206, and provides the moisture data to the central control system 206 through the electrical connection.

Based on the moisture data, the central control system 206 decides how much water to put down in each zone. The central control system 206 activates the water control valves 202, which permits water from the water supply 204 to flow through the water control valves 202. Further, based on the moisture data, the central control system 206 configures the electrically adjustable spray pattern 104 of the sprinklers 102.

The central control system 206 includes one or more computers. The computers include, by way of example, processors, program logic, or other substrate configurations representing data and instructions, which operate as described herein. In other embodiments, the processors can include controller circuitry, processor circuitry, processors, general-purpose single-chip or multi-chip microprocessors, digital signal processors, embedded microprocessors, microcontrollers and the like.

The central control system 206 includes information relating to the locations of the sprinklers 102, the area watered or the maximum spray pattern of each sprinkler 200, watering zones controlled by each zone controller 210, and the like.

The central control system 206 processes the moisture data to determine which areas require moisture. The central control system 206 provides instructions to configure the spray pattern 104 of the sprinklers 102, such that the areas requiring moisture are watered, and the areas not requiring moisture are not watered.

In one embodiment, the central control system 206 provides instructions to the zone controller 210 through the wireless transmission system or the electrical connection, as described above. The zone controller 210 then provides the instructions to the sprinkler 200 through the wireless transmission system or the electrical connection, as described above.

In another embodiment, the central control system 206 provides instructions directly to the sprinkler 102 through the wireless transmission system or the electrical connection, as described above.

In another embodiment, the multi-zone sprinkler system 100 further includes fire sensors 208. The fire sensors 208 are, for example, smoke detectors, infrared detectors, ultraviolet (UV) detectors, infrared cameras, temperature sensors, or the like. The fire sensors 208 provide fire data to the central control system 206 directly or through the zone controller 210 through the wireless transmission system or an electrical connection, as described above. Based on the fire data, the central control system 206 provides instructions to configure the spray pattern 104 of the sprinklers 102, as described above, such that the areas requiring moisture are watered.

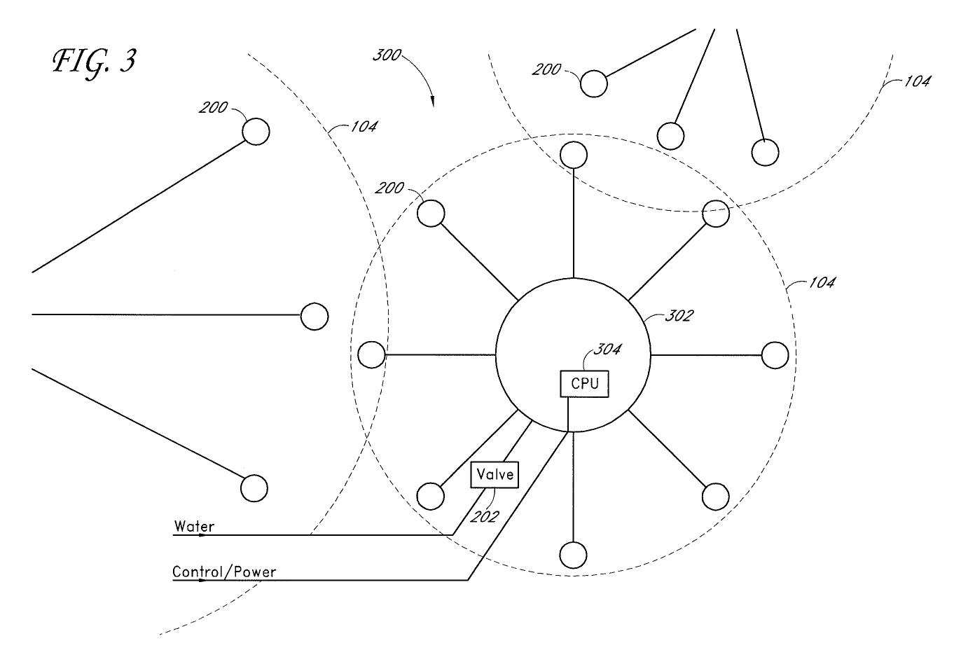

FIG. 3 is a schematic diagram of a sprinkler system 300. The sprinkler system 300 includes the sprinkler 102 having the adjustable spray pattern 104, and the first level moisture sensors 200. The sprinkler 102 includes a sprinkler head 302, which includes at least one computer 304.

The computer 304 includes, by way of example, processors, program logic, or other substrate configurations representing data and instructions, which operate as described herein. In other embodiments, the processors can include controller circuitry, processor circuitry, processors, general-purpose single-chip or multi-chip microprocessors, digital signal processors, embedded microprocessors, microcontrollers and the like.

The sprinkler head 302 receives water when the water control valve 202 activates. The computer 304 receives control data and power from a central location, such as the central control system 206. In another embodiment, the computer 304 receives only power from the central location.

At least one moisture sensor 200 is associated with and electrically connects to the sprinkler head 302. In one embodiment, two or more first level moisture sensors 200 form a circular pattern around the sprinkler head 300.

The first level moisture sensors 200 provide the moisture data to the computer 304. In one embodiment, the computer 304 provides the moisture data to the central control system 206 and receives instructions to configure the spray pattern 104 from the central control system 206. In another embodiment, the computer 304 receives the moisture data, processes the moisture data to determine the correct spray pattern 104, and configures the spray pattern 104 based on the moisture data.

FIG. 3 illustrates the adjustable spray patterns 104 partially overlapping. In another embodiment, the adjustable spray patterns 104 do not overlap. In a further embodiment, the adjustable spray patterns 104 overlap, such that the area of the sprinkler system 300 is watered by at least one sprinkler 102.

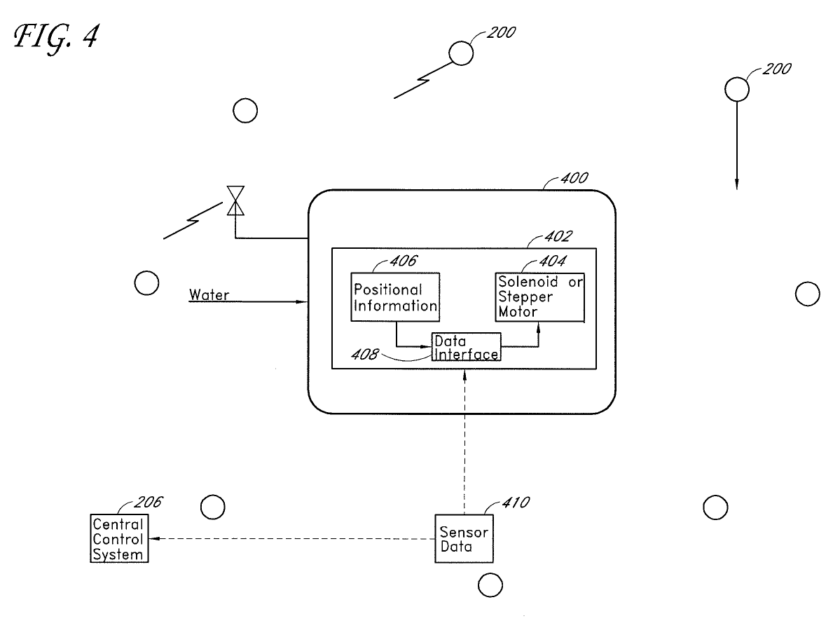

FIG. 4 is a schematic diagram of one embodiment of a rotating sprinkler 400. The rotating sprinkler 400 rotates in a 360 degree arc, or portions of the 360 degree arc, when water flows through the sprinkler 400. In one embodiment, the rate of rotation through various portions of the arc determines the quantity of water applied to the area surrounding the sprinkler 400. As the sprinkler slowly rotates, the sprinkler 400 applies more water. When the sprinkler 400 rotates relatively quickly, relatively less water is applied.

The sprinkler 400 includes a sprinkler head 402. The sprinkler head 402 includes an actuator 404, positional information 406, and a data interface 408. The positional information 406 received through the data interface 408 controls the activation of the actuator 404. The actuator 404 controls the rate of rotation of the sprinkler head 402. Typically, the sprinkler 400 would be used in a golf course or other industrial application with rotating sprinklers.

In one embodiment, when the actuator 404 is open or active, the sprinkler head 402 rotates quickly. In another embodiment, when the actuator 404 is closed or inactive, the sprinkler head 402 rotates slowly.

The water supply 204, through the activated water supply valve 202, supplies water to the sprinkler 400. The moisture sensor 200 sends moisture data 410 to the central control system 206 directly or through the sprinkler 400 via the wireless transmission system or electrical connections, or a combination of the wireless transmission system or the electrical connections.

Based on the moisture data 410, the central control system 206 sends positional information 406 through the data interface 408 to the sprinkler 400 via the wireless transmission system or electrical connections, or a combination of the wireless transmission system or the electrical connections. Using the positional information, the sprinkler 400 opens or closes the actuator 404 to control the speed at which the sprinkler head 402 rotates.

In another embodiment, the sprinkler 400, using the computer 304, determines the positional information 406 based on the moisture data 410. Using the positional information from the computer 304, the sprinkler 400 opens or closes the actuator 404 to control the rate of rotation of the sprinkler head 402.

Although FIG. 4 shows the rotating sprinkler 400 having an actuator, other suitable devices such as solenoids, stepper motors, switches, relays, valves or the like can be used to control the rate of rotation of the sprinkler 400.

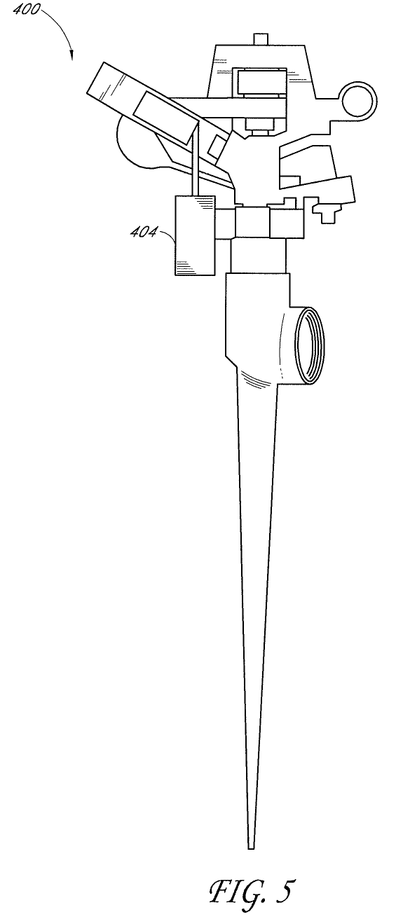

FIG. 5 is a schematic diagram of one embodiment of the sprinkler 400 having the actuator 404. The actuator 404 can be, for example, a solenoid, a stepper motor, a switch, a relay, a valve, or the like.

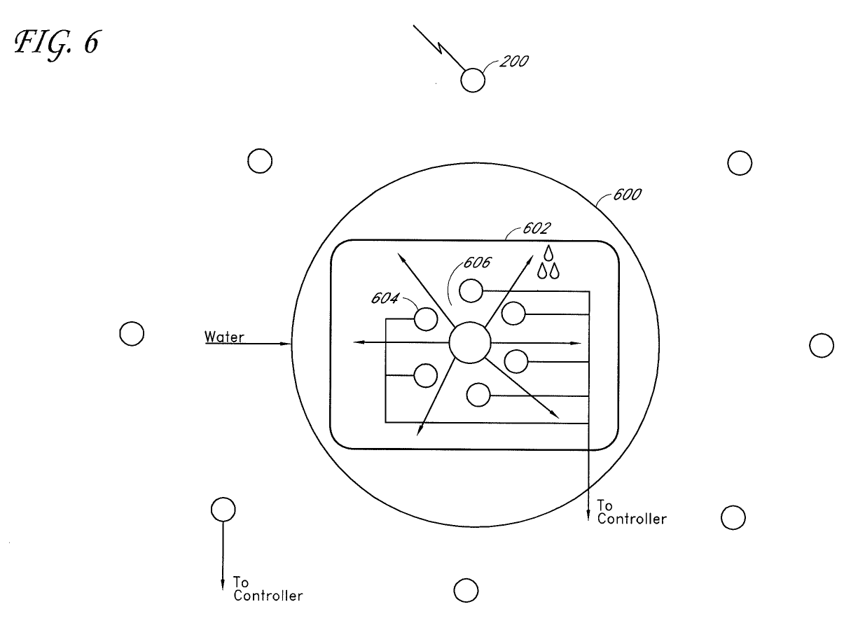

FIG. 6 is a schematic diagram of one embodiment of a non-rotating sprinkler 600. The sprinkler 600 includes a sprinkler head 602. The sprinkler head 602 includes at least one port actuator 604 having an active state and an inactive state. Each port actuator 604 controls a port 606 associated with the port actuator 604. In one embodiment, the actuators 604 and their associated ports 606 form a ring around the perimeter of the sprinkler head 602. For example, eight solenoids could be used to control eight zones of a circular patterns around the sprinkler 600. Typically, the sprinkler 600 would be used in a residential application or other application with non-rotating sprinklers.

The water supply 204 through the activated water supply valve 202 supplies water to the sprinkler 600. When the port 606 is open, water flows through the port 606.

In one embodiment, when the port actuator 604 is active, the port 606 is open. In another embodiment, when the port actuator 604 is active, the port 606 is closed. In another embodiment, when the port actuator 604 is inactive, the port 606 is closed. In a yet further embodiment, when the port actuator 604 is inactive, the port 606 is open.

Based on the moisture data 410, the central control system 206 sends state information to the sprinkler 600 to control the state of the actuators 604. The actuators 604 open the ports 606 as determined by the state information. The sprinkler 600 waters the area associated with the open ports 606.

In another embodiment, the sprinkler 600, using the computer 304, controls the state of the actuators 604 based on the moisture data 410. The sprinkler 600 activates the actuators 604 to open the ports 606, which waters the areas associated with the open ports 606.

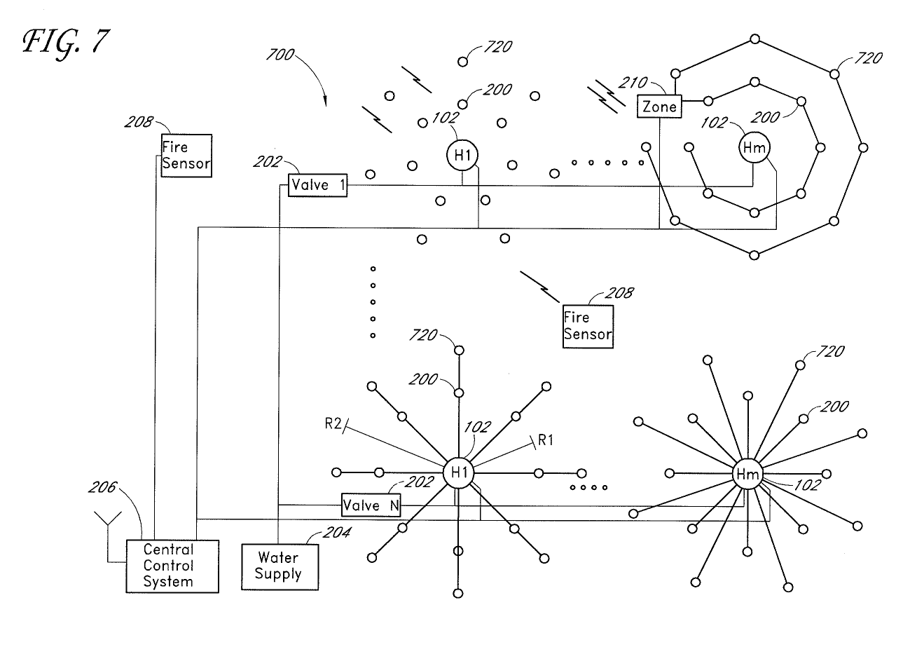

FIG. 7 is a schematic diagram of another embodiment of a multi-zone sprinkler system 700 configured to water areas of a zone. The sprinkler system 700 includes the sprinklers 102, first level moisture sensors 200, second level moisture sensors 720, the water supply valves 202, the water supply 204, and the central control system 206.

In a typical arrangement, a series of water supply valves 202 each connect to the water supply 204. Each water supply valve 202 connects to one or more sprinklers 102, each sprinkler 102 having the adjustable spray pattern 104. When a switch or solenoid in the water supply valve 202 activates, the water from the water supply flows through the water supply valve 202. In some embodiments, the water supply 204 supplies water through the water supply valve 202 at differing flow parameters, such as, for example, volume, velocity, rate, pressure, etc. In other embodiments, the water supply valve 202 provides water at varying flow parameters such as volume, velocity, rate, pressure, etc. Depending on the spray pattern 104 of the sprinkler 102, the sprinkler 102 waters some, all, or none of the area surrounding the sprinkler 102. In one embodiment, the sprinkler system 700 is arranged in watering zones. In some embodiments, the sprinkler 102 is configured to water areas at varying distances away from the sprinkler 102. For example, in one embodiment, the sprinkler 102 waters areas in a zone corresponding to a first distance away from the sprinkler 102. In other embodiments, the sprinkler 102 waters areas in a zone corresponding to a second distance away from the sprinkler 102.

In one arrangement, the multi-zone sprinkler system 700 includes at least one water control valve 202, and at least one sprinkler 102 having an adjustable spray pattern 104. As described herein, the adjustable spray pattern 104 can be configured to water areas of the zone that correspond to varying distances from the sprinkler 102.

The first level moisture sensors 200 and the second level moisture sensors 720 are provided to sense the moisture in the soil. The first level moisture sensors 200 and the second level moisture sensors 720 can be provided in any suitable location, such as, for example, near the facility where the central control system 206 is located. In some embodiments, the first level moisture sensors 200 and the second level moisture sensors 720 are remote sensors located above ground on structures such as, for example, antennas, poles, trees, buildings, houses, etc. In some embodiments, the first level moisture sensors 200 and the second level moisture sensors 720 are in the soil surrounding the sprinkler 901. In other embodiments, the first level moisture sensors 200 and the second level moisture sensors 720 are remote sensors located in regions different from the area to be watered, such as, for example, a weather station.

As shown in FIG. 7, the first level moisture sensors 200 and the second level moisture sensors 720 form a relatively circular or semi-circular arrangement around each sprinkler 102. In other embodiments, the first level moisture sensors 200 and the second level moisture sensors 720 are arranged in other geometric configurations, such as, for example, rectangles, squares, ovals, or the like. The first level moisture sensors 200 and the second level moisture sensors 720 provide data indicating the moisture content of the soil to the central control system 206. In other embodiments, the first level moisture sensors 200 and the second level moisture sensors 720 send the moisture data to the sprinkler 102. In still other embodiments, the first level moisture sensors 200 and the second level moisture sensors 720 send the moisture data to any other system configured to analyze the moisture data including, without limitation, personal computers, mobile devices, other types of stand-alone computing devices, or the like.

As shown in FIG. 7, the first level moisture sensors 200 are located at approximately a radial distance R1 from the sprinkler 102 and the second level moisture sensors 720 are located at approximately a radial distance R2 from the sprinkler 102. The adjustable spray pattern 104 can be configured to water areas located at varying distances. For example, the adjustable spray pattern 104 can water areas of the zone corresponding to the radial distance R1. In other embodiments, the adjustable spray pattern 104 can water areas corresponding to the radial distance R2. In still other embodiments, the adjustable spray pattern 104 can be configured to water regions corresponding to both the radial distance R1 and the radial distance R2. In a further embodiment, the adjustable spray pattern 104 can be configured to water areas located near other radial distances from the sprinkler 102, as described herein.

In one embodiment, the first level moisture sensors 200 and the second level moisture sensors 720 provide data to the central control system 206 via a radio frequency (RF) link, or other wireless transmission system. The sprinklers 102 provide the moisture data to the central control system 206. In some embodiments, the first level moisture sensors 200 and the second level moisture sensors 720 collect moisture data and provide the moisture data to the sprinkler 102 using a wireless system.

In another embodiment, the first level moisture sensors 200 and the second level moisture sensors 720 electrically connect to the sprinklers 102 and the sprinklers 102 communicate with the central control system 206 via the wireless transmission system. The first level moisture sensors 200 and the second level moisture sensors 720 collect the moisture data and provide the moisture data through the electrical connection to the sprinklers 102. The sprinklers 102 provide the moisture data via the wireless transmission system, such as the RF link, to the central control system 206.

In another embodiment, the first level moisture sensors 200 and the second level moisture sensors 720 electrically connect to the sprinklers 102 and the sprinklers 102 electrically connect to the central control system 206. The first level moisture sensors 200 and the second level moisture sensors 720 collect the moisture data and provide the moisture data through the electrical connection to the sprinklers 102. The sprinklers 102 provide the moisture data through the electrical connection to the central control system 206.

In another arrangement still with reference to FIG. 7, the first level moisture sensors 200 and the second level moisture sensors 720 can be configured to provide the moisture data using different methods. For example, the first level moisture sensors 200 electrically connect to the sprinklers 102 and the sprinklers 102 electrically connect to the central control system 206. The first level moisture sensors 200 collect the moisture data and provide the moisture data through the electrical connection to the sprinklers 102. The second level moisture sensors 720 provide the moisture data to the central control system 206 via a radio frequency (RF) link, or another wireless transmission system. In other embodiments, the first level moisture sensors 200 provide the moisture data to the central control system 206 via a wireless transmission system whereas the second level moisture sensors 720 provide the moisture data using an electrical connection, for example, through the sprinklers 102. In still further embodiments, one of the first level moisture sensors 200 or the second level moisture sensors 720 provides moisture data to the sprinkler 102 using an electrical connection whereas the other level of moisture sensor provides moisture data to the sprinkler 102 using a wireless transmission system. The sprinkler 102 then provides the moisture data to the central control system 206 using an electrical connection or a wireless transmission system or a combination of an electrical connection and a wireless transmission system.

Based on the moisture data, the central control system 206 decides how much water to put down in each zone. The central control system 206 activates the water control valves 202, which permits water from the water supply 204 to flow through the water control valves 202. As previously mentioned, various flow parameters of water (such as, without limitation, volume, pressure, velocity, rate, or the like) that is supplied through the water control valves 202 can be adjustable. As discussed herein, the central control system 206 can be configured to control the flow parameters of water flowing through the water control valves 202. Further, based on the moisture data, the central control system 206 can be configured to control the electrically adjustable spray pattern 104 of the sprinklers 102. In some embodiments, the central control system 206 configures the flow parameters of water to adjust the electrically adjustable spray pattern 104. The central control system 206 can control the flow parameters such that water is projected to portions of the zone corresponding to other distances.

The central control system 206 can include one or more computers. The computers include, by way of example, processors, program logic, or other substrate configurations representing data and instructions, which operate as described herein. In other embodiments, the processors can include controller circuitry, processor circuitry, processors, general-purpose single-chip or multi-chip microprocessors, digital signal processors, embedded microprocessors, microcontrollers and the like.

The central control system 206 includes various types of information relating to the sprinkler system 700. In some embodiments, the central control system 206 uses information including one or more of locations of the sprinklers 102, the area watered or the range of distances watered by the spray pattern of each sprinkler 102 (minimum and maximum distances), the locations of the first level moisture sensors 200, the locations of the second level moisture sensors 720, or the watering zones controlled by each zone controller 210, and the like. In other embodiments, the central controls system 206 uses information relating to the maximum radial distance reach of the spray pattern 104 of each sprinkler 102.

The central control system 206 processes the moisture data to determine which areas require moisture. The central control system 206 provides instructions to the sprinklers 102 such that the spray pattern 104 of the sprinklers 102 provides relatively more water to the areas needing more moisture, and provides relatively less water to the areas needing less moisture. In one embodiment, the central control system 206 provides instruction to the sprinkler such that the spray pattern 104 applies water to regions needing moisture, and does not apply water to regions that do not need moisture. In some embodiments, the central control system 206 provides instructions such that the adjustable spray pattern 104 applies water to regions corresponding to a first radial distance away from the sprinkler 102, such as, for example, regions located near the first level moisture sensors 200. In other embodiments, the central control 206 provides instructions such that the adjustable spray pattern 104 provides water to areas corresponding to a second radial distance away from the sprinkler 102, such as, for example, areas of the zone in which the second level moisture sensors 720 are located. In other embodiments, the central control 206 provides instructions such that the adjustable spray pattern 104 applies water to portions of the zone to be watered corresponding to both the first radial distance and the second radial distance away from the sprinkler 102, such as, for example, portions of the zone in which both the first level moisture sensors 200 and the second level moisture sensors 720 are located. In still other embodiments, the central control 206 provides instructions to the adjustable spray pattern 104 of the sprinklers 102 such that the adjustable spray pattern 104 provides water to regions located at other distances. The spray pattern 104 can be configured to apply water to regions corresponding to varying distances away from the sprinkler 102.

In one embodiment, the central control system 206 provides instructions to the zone controller 210 through the wireless transmission system or the electrical connection, as described above. The zone controller 210 then provides the instructions to the sprinkler 102 through the wireless transmission system or the electrical connection, as described above.

In another embodiment, the central control system 206 provides instructions directly to the sprinkler 102 through the wireless transmission system or the electrical connection, as described above.

Although FIG. 7 illustrates all of the first level moisture sensors 200 relatively located at the radial distance R1 and all of the second level moisture sensors 720 relatively located at the radial distance R2, skilled artisans appreciate that each one of the first level moisture sensors 200 and/or the second level moisture sensors 720 can be located at varying radial distances.

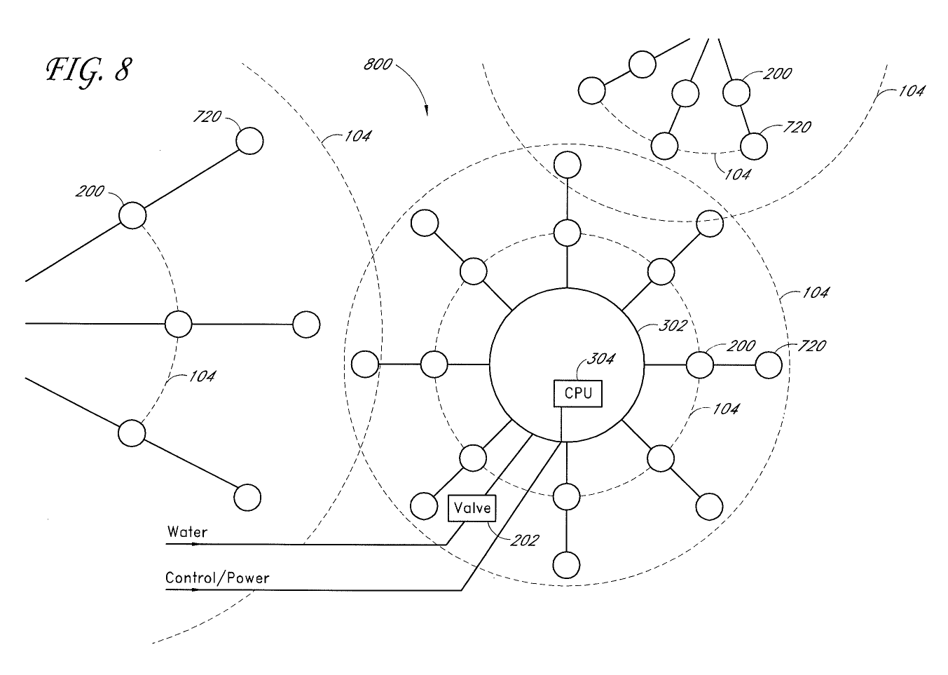

FIG. 8 is a schematic diagram of a sprinkler system 800. The sprinkler system 800 includes the sprinkler 102 having the adjustable spray pattern 104, and the first level moisture sensors 200 and the second level moisture sensors 720. The sprinkler 102 includes a sprinkler head 302, which includes at least one computer 304.

At least one of the first level moisture sensor 200 or the second level moisture sensor 720 is associated with the sprinkler head 302 and is able to provide moisture data to the sprinkler head 302, for example, using an electrical connection. In one embodiment, two or more of the first level moisture sensors 200 and the second level moisture sensors 720 forms a circular pattern around the sprinkler head 302.

The first level moisture sensors 200 and the second level moisture sensors 720 provide the moisture data to the computer 304. In one embodiment, the computer 304 provides the moisture data to the central control system 206 and receives instructions to configure the spray pattern 104 from the central control system 206. In another embodiment, the computer 304 receives the moisture data, processes the moisture data, and configures the spray pattern 104 based on the moisture data 104.

The sprinkler 102 can be configured to project water to various distances away from the sprinkler 102. In one embodiment, the spray pattern 104 is configured to water areas corresponding to a first radial distance away from the sprinkler 102. In other embodiments, the sprinkler 102 waters regions in which the first level moisture sensors 200 are located. In one embodiment, the spray pattern 104 is configured to water areas corresponding to a second radial distance, such as, for example, areas of the zone in which the second level moisture sensors 720 are located. In other embodiments, the spray pattern 104 is configured to water areas located at different radial distances from the first radial distance and the second radial distance. In other embodiments, the spray pattern 104 is configured to water areas corresponding to other levels of moisture sensors, such as, for example, third or fourth level moisture sensors (not shown). In still some embodiments, the adjustable spray pattern 104 is configured to water areas corresponding to varying distances such as regions between the first radial distance and the second radial distance, areas between the sprinkler 102 and the first radial distance, areas located at farther distances than the second radial distance, etc.

FIG. 8 illustrates one embodiment of the sprinkler system 800 where the adjustable spray patterns 104 are partially overlapping. In another embodiment, the adjustable spray patterns 104 do not overlap. In a further embodiment, the adjustable spray patterns 104 overlap such that the area of the sprinkler system 800 is watered by at least one sprinkler 102.

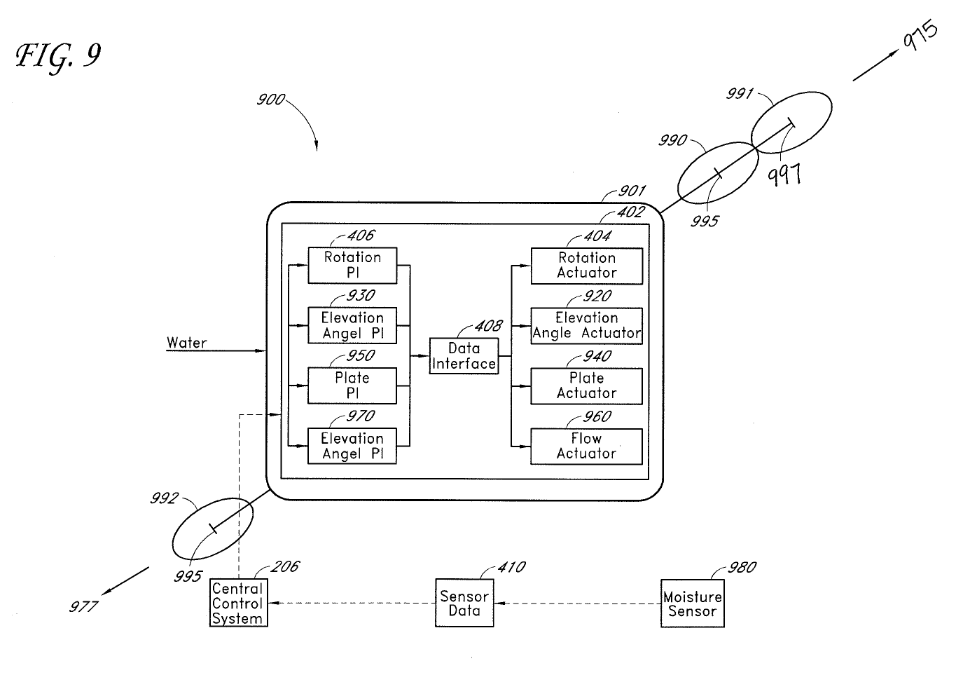

FIG. 9 is a schematic diagram of one embodiment of a multi-zone sprinkler system 900. The sprinkler system 900 includes a rotating sprinkler 901, the central control station 206, the sensor data 410, and a remote moisture sensor 980. The rotating sprinkler 901 includes the sprinkler head 402.

The rotating sprinkler 901 can be configured to rotate in a 360 degree arc, or portions of the 360 degree arc. In one embodiment, water power is used to activate the rotation of the rotating sprinkler 901. The rotating sprinkler 901 is activated when water flows through the rotating sprinkler 901. The rotating sprinkler 901 does not rotate when there is no water flowing through the rotating sprinkler 901.

In one embodiment, the rotating sprinkler 901 is electrically configured to rotate in a 360 arc, or portions of the 360 degree arc. In one embodiment, the rotational rate actuator 404 is used to activate the rotating sprinkler 901. When the rotational rate actuator 404 is in a first state, the rotating sprinkler 901 does not rotate and there is no water flowing through the rotating sprinkler 901. When the rotational rate actuator 404 is in a second state, the rotating sprinkler 901 is activated and rotates at a first rate, such as, for example, a relatively slow rate. In one embodiment, when the rotating sprinkler 901 is rotating at the first rate, the rotating sprinkler 901 applies relatively more water to the areas of the zone through which the rotating sprinkler 901 is rotating. When the rotating rate actuator 404 is in a third state, the rotating sprinkler 901 rotates at a second rate that is, for example, relatively quicker than the first rate. In one embodiment, when the rotating sprinkler 901 is rotating at the second rate, the rotating sprinkler 901 applies relatively less or no water to the areas of the zone through which the rotating sprinkler 901 is rotating.

In another embodiment, the rotating sprinkler 901 is electrically configured to rotate in a 360 arc, or portions of the 360 degree arc, for example, using a rotation activation actuator. Using a rotation activation actuator to activate the rotation of the rotating sprinkler 901 enables the rotation rate actuator 404 to provide more states to control the rates at which the rotation sprinkler 901 rotates. When the rotational activation actuator is in a first state, the rotating sprinkler 901 does not rotate and there is no water flowing through the rotating sprinkler 901. When the rotation activation actuator is in a second state, the rotating sprinkler 901 is activated and rotates at a first rate, such as, for example, a relatively slow rate. In one embodiment, when the rotating sprinkler 901 is rotating at the first rate, the rotating sprinkler 901 applies relatively more water to the areas of the zone through which the rotating sprinkler 901 is rotating. When the rotation activation actuator is in a third state, the rotating sprinkler 901 is activated and rotates at a second rate, such as, for example, a relatively quicker rate. In one embodiment, when the rotating sprinkler 901 is rotating at the second rate, the rotating sprinkler 901 applies relatively less or no water to the areas of the zone through which the rotating sprinkler 901 is rotating. The rotating sprinkler 901 can then use the rotational rate actuator 404 to further adjust the rates at which the rotating sprinkler 901 rotates. For example, in one embodiment, the rotational rate actuator 404 has three states and can be used to adjust the rotating sprinkler 901 to rotate at a different third rate, a fourth rate, and/or a fifth rate.

In FIG. 9, the rotating sprinkler 901 can be manually configured to control the rate of rotation of the rotating sprinkler 901. For example, users of the rotating sprinkler 901 can manually adjust a setting on the rotating sprinkler 901 such that when the rotating sprinkler 901 is going through portions of the arc that correspond to a first area, the rotating sprinkler 901 rotates relatively slowly, thereby applying relatively more water to the first area. Users can also manually adjust the setting on the rotating sprinkler 901 such that when the rotating sprinkler 901 is going through portions of the arc that correspond to a second area, the rotating sprinkler 901 rotates relatively quickly, thereby applying relatively less or no water to the second area.

As mentioned in connection to FIG. 4, the rate of rotation of the rotating sprinkler 901 can also be electrically configured to control the quantity of water applied to the area surrounding the rotating sprinkler 901. For example, in one embodiment, the rotating sprinkler 901 applies relatively more water when the rotating sprinkler 901 rotates relatively slowly. In another embodiment, the rotating sprinkler 901 applies relatively less or no water when the rotating sprinkler 901 rotates relatively quickly. In some embodiments, the rotating sprinkler 901 rotates relatively slowly and applies relatively more water in areas that are indicated as needing water by the remote moisture sensor 980. In another embodiment, the rotating sprinkler 901 rotates relatively quickly and applies relatively less or no water to areas of the zone that are indicated by the remote moisture sensor 980 as not needing water. In other embodiments, the rotating sprinkler 901 rotates relatively slowly to apply water to areas that need moisture and rotates relatively quickly not to apply water to areas that do not need water.

Further, the rotating sprinkler 901 of FIG. 9 is configured to water areas of the zone located at varying distances away from the rotating sprinkler 901. The rotating sprinkler 901 includes adjustable parameters to control the distances at which a region is watered, such as, for example, position of the sprinkler head 402, position of the sprinkler nozzle controlled by the elevation angle actuator 920, position of the spreader plate controlled by the spreader plate actuator 910, flow parameters of water flowing through the sprinkler head 402, etc.

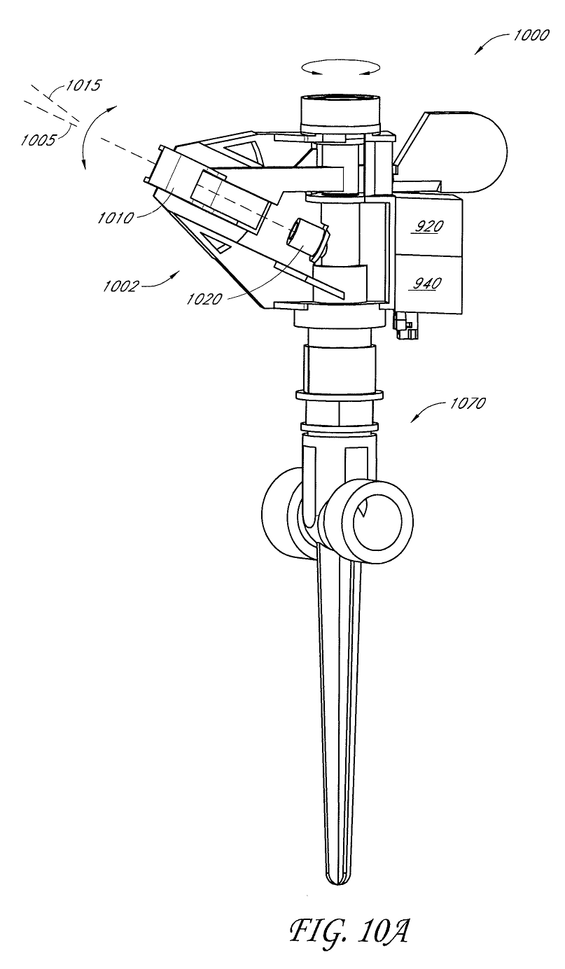

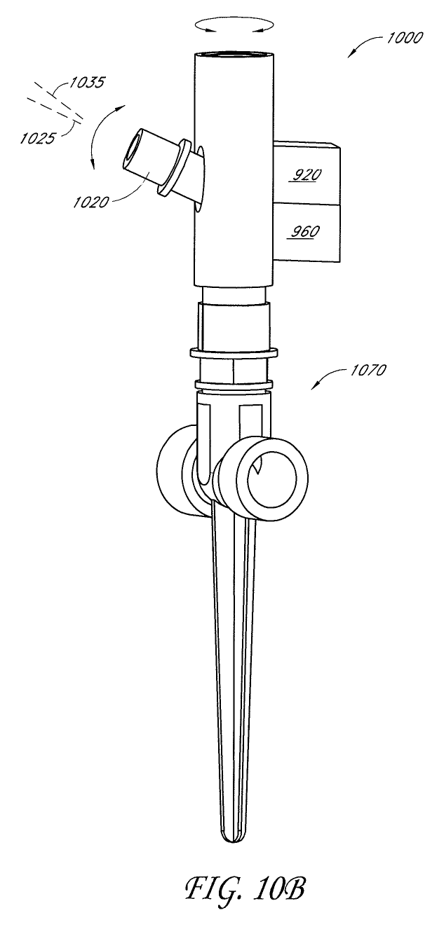

With reference to FIG. 9, several embodiments disclosed herein describe the various methods of adjusting the parameters of the rotating sprinkler 901 such that the adjustable spray pattern 104 waters areas of the zone corresponding to various distances away from the rotating sprinkler 901. In one embodiment, the elevation angle of the adjustable spray pattern 104 is controllable. In one embodiment, the elevation angle is controlled by adjusting the angle of the sprinkler head 402, as shown in connection with FIG. 10A. When the sprinkler head 402 is in a first position, the sprinkler head 402 projects the adjustable spray pattern 104 in a first direction at a first elevation angle. When the adjustable spray pattern 104 is projected in the first direction, the adjustable spray pattern 104 applies water to regions of the zone that correspond to a first radial distance away from the rotating sprinkler 901. When the sprinkler head 402 is in a second position, the sprinkler head 402 projects the adjustable spray pattern 104 in a second direction at a second elevation angle. When the adjustable spray pattern 104 is projected in the second direction, the adjustable spray pattern 104 applies water to portions of the zone corresponding to a second radial distance away from the rotating sprinkler 901.

In another embodiment, the position of a sprinkler nozzle is adjusted to control the elevation angle of the adjustable spray pattern 104, thereby controlling where the adjustable spray pattern 104 applies water. In one embodiment, the elevation angle of the adjustable spray pattern 104 is controlled by adjusting the angular position of a sprinkler nozzle, as shown in connection with FIG. 10B. When the sprinkler nozzle is in a first position, the rotating sprinkler 901 projects the adjustable spray pattern 104 in a first direction (for example, at a first elevation angle). When the adjustable spray pattern 104 is projected in the first direction, the adjustable spray pattern 104 waters areas of the zone corresponding to a first radial distance away from the rotating sprinkler 901. When the sprinkler nozzle is in a second position, the rotating sprinkler 901 projects the adjustable spray pattern 104 in a second direction (for example, at a second elevation angle). When the adjustable spray pattern 104 is projected in the second direction, the adjustable spray pattern 104 waters areas of the zone corresponding to a second radial distance away from the rotating sprinkler 901.

In another embodiment, the spreader plate of the rotating sprinkler 901 is adjusted to control the distances at which the rotating sprinkler 901 applies water to portions of the zone to be watered. When the spreader plate of the rotating sprinkler 901 is in a first position, the adjustable spray pattern 104 waters areas corresponding to a first location. When the spreader plate of the rotating sprinkler 901 is in a second position, the adjustable spray pattern 104 applies water to regions corresponding to a second location. In one embodiment the first location is at a first radial distance away from the rotating sprinkler 901 and the second location is at a second radial distance away from the rotating sprinkler 901.

In another embodiment, the flow parameter (for example, volume, velocity, rate, pressure, or the like) of water going through the sprinkler head 402 is adjusted to control the distances at which the adjustable spray pattern 104 waters areas. When the flow of water going through the sprinkler head 402 is at a first setting, the adjustable spray pattern 104 waters areas of the zone corresponding to a first radial distance away from the rotating sprinkler 901. When the flow of water going through the sprinkler head 402 is at a second setting, the adjustable spray pattern 104 waters areas of the zone corresponding to a second radial distance away from the rotating sprinkler 901. In some embodiments, the flow parameter adjusted is the volume of the water flowing through the rotating sprinkler 901. When the water flowing through the rotating sprinkler 901 is at a first volume, the adjustable spray pattern 104 waters areas located a first radial distance away from the rotating sprinkler 901. When the water flowing through the rotating sprinkler 901 is at a second volume, the adjustable spray pattern 104 waters areas corresponding to a second radial distance away from the rotating sprinkler 901. In other embodiments, the flow parameter adjusted is the rate of the water flowing through the rotating sprinkler 901. In still other embodiments, the flow parameter adjusted is the velocity of the water flowing through the rotating sprinkler 901.

In another embodiment, two or more of the adjustable parameters of the rotating sprinkler 901 such as the rate of rotation of the sprinkler head 402, the elevation angle of the adjustable spray pattern 104, the position of the spreader plate, or the flow parameter of water going through the sprinkler head 402 can be adjusted to control the adjustable spray pattern 104.

The sprinkler head 402 includes the rotation rate actuator 404, an elevation angle actuator 920, a spreader plate actuator 940, a water flow actuator 960, rotation rate positional information 406, elevation angle positional information 930, spreader plate positional information 950, water flow positional information 970, and the data interface 408. The rotation rate positional information 406 received through the data interface 408 controls the activation of the rotation rate actuator 404. The rotation rate actuator 404 controls the rate of rotation of the sprinkler head 402. The elevation angle positional information 930 received through the data interface 408 controls the activation of the elevation angle actuator 920. The elevation angle actuator 920 controls the elevation angle of spray pattern 104. The spreader plate positional information 930 received through the data interface 408 controls the activation of the spreader plate actuator 940. The spreader plate actuator 940 controls the position of the spreader plate. The water flow positional information 970 received through the data interface 408 controls the activation of the water flow actuator 960. The water flow actuator 960 controls various parameters of the flow of water going through the sprinkler head 402, such as, for example, volume, rate, velocity, pressure, etc.

As already mentioned, the rotation rate actuator 404 controls the rate of rotation of the sprinkler head 402. In one embodiment, when the rotation rate actuator 404 is in a first state (for example, open or active), the sprinkler head 402 rotates at a first rate, for example, relatively quickly. In another embodiment, when the rotation rate actuator 404 is in a second state (for example, closed or inactive), the sprinkler head 402 rotates at a second rate, such as, for example, relatively slowly. In some embodiments, when the rotation rate actuator 404 is in a third state (for example, neutral or default state where the actuator is neither active nor inactive), the sprinkler head 402 rotates at a third rate (for example, even slower than the second rate, quicker than the first rate, or quicker than the second rate but slower than the first rate).

The elevation angle positional information 930 received through the data interface 408 controls the activation of the elevation angle actuator 920. In one embodiment, the elevation angle actuator 920 controls the elevation angle of spray pattern 104 by controlling the position of the sprinkler head 402. In one embodiment, when the elevation angle actuator 920 is in a first state, the sprinkler head 402 is in a first position. In another embodiment, when the elevation angle actuator 920 is in a second state, the sprinkler head 402 is in a second position. In some embodiments, when the elevation angle actuator 920 is in a third state, the sprinkler head 402 is in a third position. In some embodiments, the elevation angle actuator 920 controls the position of the sprinkler head 402 by adjusting the angular position of the sprinkler head 402 relative to a sprinkler shaft (not shown).

The elevation angle positional information 930 received through the data interface 408 also can be configured to control the activation of the elevation angle actuator 920 by separately controlling the position of the sprinkler nozzle. In one embodiment, when the elevation angle actuator 920 is in a first state, the sprinkler nozzle is in a first position. In another embodiment, when the elevation angle actuator 920 is in a second state, the sprinkler nozzle is in a second position. In some embodiments, when the elevation angle actuator 920 is in a third state (for example, a neutral state where the elevation angle actuator 920 is neither active nor inactive), the sprinkler nozzle is in a third position. In other embodiments, the elevation angle actuator 920 controls the position of the sprinkler nozzle by adjusting the angular position of the nozzle (either together with the sprinkler head 402 or separately) relative to a sprinkler shaft (for example, the sprinkler shaft 1070 shown in connection with FIG. 10A).

Still with reference to FIG. 9, in certain arrangements, the spreader plate positional information 930 received through the data interface 408 controls the activation of the spreader plate actuator 940. The spreader plate actuator 940 controls the position of the spreader plate. For example, when the spreader plate actuator 940 is in a first state, the spreader plate is in a first position. In another embodiment, when the spreader plate actuator 940 is in a second state, the spreader plate is in a second position. In yet another embodiment, when the spreader plate actuator 940 is in a third state, the spreader plate is in a third position.

In another embodiment, the water flow positional information 970 received through the data interface 408 controls the activation of the water flow actuator 960. The water flow actuator 960 controls various parameters of the flow of water going through the sprinkler head 402, such as, for example, volume, rate, velocity, pressure, etc. In one embodiment, when the water flow actuator 960 is in a first state, water goes through the sprinkler head 402 at a first setting. In another embodiment, when the water flow actuator 960 is in a second state, water goes through the sprinkler head 402 at a second setting. In yet a further embodiment, when the water flow actuator 960 is in a third state, water goes through the sprinkler head 402 at a third setting.

The water supply 204, through the activated water supply valve 202, supplies water to the rotating sprinkler 901. In some embodiments, the water flow actuator 960 is located elsewhere from the rotating sprinkler 901, such as, for example, the water supply 204. In other embodiments, the water flow positional information 970 is located elsewhere from the rotating sprinkler 901, such as, for example, the water supply 204. In one embodiment, the water flow actuator 960 remains on the sprinkler 901 and the water supply 204 includes a water supply actuator (not shown) to control the flow parameters of the water supplied to the rotating sprinkler 901. In another embodiment, the water flow positional information 970 remains on the rotating sprinkler 901 and the water supply 204 includes a water supply positional information (not shown) to control the water supply actuator of the water supply 204.

Still with reference to FIG. 9, in one embodiment, when the water supply actuator of the water supply 204 is in a first state, water flows through the sprinkler head 402 at a first setting. In another embodiment, when the water supply actuator of the water supply 204 is in a second state, water flows through the sprinkler head 402 at a second setting. In a further embodiment, when the water supply actuator of the water supply 204 is in a third state, water flows through the sprinkler head 402 at a third setting.

In some arrangements, the water flow actuator 960 is located elsewhere from the rotating sprinkler 901, such as, for example, the water supply valve 202. In other embodiments, the water flow positional information 970 is located elsewhere from the rotating sprinkler 901, such as, for example, the water supply valve 202. In one embodiment, the water flow actuator 960 remains on the sprinkler 901 and the water supply valve 202 includes a water supply valve actuator (not shown) to control the flow parameters of the water supplied to the rotating sprinkler 901. In another embodiment, the water flow positional information 970 remains on the rotating sprinkler 901 and the water supply valve 202 includes a water supply valve positional information (not shown) to control the water supply valve actuator.

In one embodiment, when the water supply valve actuator of the supply valve 202 is in a first state, water flows through the sprinkler head 402 at a first setting. In another embodiment, when the water supply valve actuator of the supply valve 202 is in a second state, water flows through the sprinkler head 402 at a second setting. In a further embodiment, when the water supply valve actuator of the supply valve 202 is in a third state, water flows through the sprinkler head 402 at a third setting.

As illustrated in FIG. 9, the remote moisture sensor 980 is configured to collect moisture data of areas to be watered by the rotating sprinkler 901. The remote moisture sensor 980 can collect moisture data using various techniques, including, without limitation, geophysical methods (time-domain reflectometry, frequency domain moisture sensing, capacitance probing, electrical resistivity tomography, etc.). In other embodiments, the remote moisture sensor 980 remotely senses the moisture content of soil using electromagnetic waves, such as, for example, microwave, ultra-violet, infrared or other types of radiation.

The remote moisture sensor 980 is configured to provide the moisture data 410 to the central control system 206, the rotating sprinkler 901, or any other system capable of receiving the moisture data 410, such as the water supply 204 and/or the water supply valve 202. In some embodiments, the remote sensor 980 senses the moisture data 410 and provides the moisture data 410 to either the central control system 206 or the rotating sprinkler 901 via a wireless transmission system or via electrical connections. In other embodiments, the remote sensor 980 provides the moisture data 410 to the central control system 206 or the rotating sprinkler 901 using a combination of the wireless transmission system and the electrical connections. In one embodiment, the remote moisture sensor 980 provides the moisture data 410 to the rotating sprinkler 901 and the rotating sprinkler 901 provides the moisture data, either wirelessly or using an electrical connection, to the central control system 206.

The remote moisture sensor 980 of FIG. 9 can be located in any suitable location, such as, for example, near the facility where the central control system 206 is located. In other embodiments, the remote moisture sensor 980 is located above ground on structures such as, for example, antennas, poles, trees, buildings, houses, etc. In some embodiments, the remote moisture sensor 980 is buried under ground, such as, for example, in the soil surrounding the sprinkler 901. In still other embodiments, the remote moisture sensor 980 may be located on extraterrestrial objects such as satellites, including weather satellites.

Based on the moisture data 410, the central control system 206 sends one or more of the rotation rate positional information 406, the elevation angle positional information 930, the spreader plate positional information 950, and/or the water flow positional information 970 through the data interface 408 to the rotating sprinkler 901 via the wireless transmission system or electrical connections, or a combination of the wireless transmission system and the electrical connections. Using the received information, the rotating sprinkler 901 adjusts the states of one or more of the rotation rate actuator 404, the elevation angle actuator 920, the spreader plate actuator 940, and/or the water flow actuator 960 to control one or more of the rate of rotation, the elevation of projection of the spray pattern 104, the position of the spreader plate, or the parameters of water flowing through the sprinkler head 402.

As shown in FIG. 9, the sprinkler system 900 controls the areas watered by the sprinkler 901 by sending positional information to the rotating sprinkler 901, the water supply 204 and the water supply valve 202 to coordinate actuators located on the rotating sprinkler 901, the water supply 204 and the water supply valve 202. For example, the central control system 206 sends the water flow positional information 970 to the water supply 204. Using the received information, the water supply 204 adjusts the state of the water flow positional actuator 960 located on the sprinkler 901 to control the parameter of water flowing through the sprinkler head 402. The water flow positional actuator 960 can be positioned on the water supply 204. Using the received information, the water supply 204 also can be configured to adjust the state of the water flow positional actuator 960 located on the water supply 204 to control the parameters of water flowing through the sprinkler head 402. In other embodiments, the central control system 206 sends information to the water supply positional information. Using the received information, the water supply 204 adjusts the state of the water supply positional actuator (not shown) to control the parameter of water flowing through the sprinkler head 402.

In some embodiments, the central control system 206 sends the water flow positional information 970 to the water supply valve 202. Using the received information, the water supply valve 202 adjusts the state of the water flow positional actuator 960 located on the sprinkler 901 to control the parameter of water flowing through the sprinkler head 402. The water flow positional actuator 960 can be positioned on the water supply valve 202. Using the received information, the water supply valve 202 also can be configured to adjust the state of the water flow positional actuator 960 located on the water supply valve 202 to control the parameters of water flowing through the sprinkler head 402. In other embodiments, the central control system 206 sends information to the water supply valve positional information. Using the received information, the water supply valve 202 adjusts the state of the water supply valve positional actuator (not shown) to control the parameters of water flowing through the sprinkler head 402.

In another embodiment, the rotating sprinkler 901, using the computer 304, controls one or more of the rotation rate positional information 406, the elevation angle positional information 930, the spreader plate positional information 950, or the water flow positional information 970 based on the moisture data 410. Using the information from the computer 304, the rotating sprinkler 901 changes the states of one or more of the rotation rate actuator 404, the elevation angle actuator 920, the spreader plate actuator 940, or the water flow actuator 960 to control one or more of the rate of rotation, the elevation of projection of the spray pattern 104, the position of the spreader plate, or the parameters of water flowing through the sprinkler head 402.

In other embodiments, the rotating sprinkler 901, using the computer 304, controls one or more of the water supply actuator or the water supply valve actuator based on the moisture data 410. Using the information from the computer 304, the rotating sprinkler 901 changes the states of one or more of the water supply actuator or the waters supply valve actuator to control the parameters of water flowing through the sprinkler head 402.

The rotation rate actuator 404, the elevation angle actuator 920, the spreader plate actuator 940, and/or the water flow actuator 960 can include suitable devices such as solenoids, stepper motors, switches, relays, valves or the like. In an embodiment, the rotation rate actuator 404, the elevation angle actuator 920, the spreader plate actuator 940, and/or the water flow actuator 960 include devices having at least 3 states, such as, for example, an active state, an inactive state, and a neutral or default state. A solenoid for use with the sprinkler 901 can include a coil attached to a current source. Another solenoid for use with the sprinkler 901 includes conductive wires coiled around a magnetic bar. In some embodiments, the rotating sprinkler 901 includes two or more actuators to control each of the rate of rotation, the elevation of projection, the position of the spreader plate or the flow of water. In further embodiments, the rotating sprinkler 901 includes two or more actuators configured in series to control each of the rate of rotation, the elevation of projection, the position of the spreader plate or the flow of water.

With continued reference to FIG. 9, one embodiment of an operation of the sprinkler 901 is described herein. The sprinkler system 900 of FIG. 9 further includes relatively dry areas indicated by a first portion 990, a second portion 991, and a third portion 992. As shown in FIG. 9, the first portion 990 and the third portion 992 approximately correspond to areas located a first radial distance 995 away from the rotating sprinkler 901. The second portion 991 approximately corresponds to areas located a second radial distance 997 away from the rotating sprinkler 901. The first portion 990 and the second portion 991 correspond to areas similarly located along a first direction 975 and the third portion 992 corresponds to areas located along a different second direction 977.

Because the first portion 990 and the third portion 992 correspond to the same first radial distance 995, the rotating sprinkler 901 can substantially water the first portion 990 and the third portion 992 without having to adjust the radial distances at which the rotating sprinkler 901 applies water. In one embodiment, the central control system 206 adjusts the rate of rotation of the rotating sprinkler 901 to water both the first portion 990 and the third portion 992. In other embodiments, although the first portion 990 and the second portion 991 correspond to the same first direction 975, the second radial distance 997 is located substantially apart from the first radial distance 996 such that the rotating sprinkler 901 adjusts the radial distances at which it projects water to sufficiently apply water to the second portion 991.

The remote moisture 980 senses the moisture content of the area around the rotating sprinkler 901 indicating that the first portion 990, the second portion 991, and the third portion 992 are relatively dry and areas that do not correspond to the first portion 990, the second portion 991, and the third portion 992 are relatively moist. The remote moisture 980 provides the moisture data 410 to a processor configured to control the adjustable parameters of the rotating sprinkler 901 such as, for example, the central control station 206. In some embodiments, the central control system 206 processes the moisture data 410 to determine which areas require moisture. The central control system 206 provides instructions to configure the spray pattern 104 such that the areas needing moisture, including the first portion 990, the second portion 991, and the third portion 992, are watered.

Because the first portion 990, the second portion 991 and the third portion 992 include areas corresponding to different radial distances and different directions, the central control system 206 can use a combination of features to effectively apply water to the first portion 990, the second portion 991 and/or the third portion 992. In one embodiment, the central control system 206 adjusts one or more of the elevation angle actuator 920, the spreader plate actuator 940, or the water flow actuator 960 such that the rotating sprinkler 901 applies water to areas corresponding to the first radial distance 995, such as, for example, the first portion 990 or the third portion 992. The central control station 206 adjusts the rotation rate of the rotating sprinkler 901 such that when the rotating sprinkler 901 is rotating through areas corresponding to the first portion 990 and/or the third portion 992, the rotating sprinkler 901 rotates at a relatively slow rate, therefore applying water to the first portion 990 and/or the third portion 992. When the rotating sprinkler 901 is rotating through areas not corresponding to the first portion 990 and/or the third portion 992, the central control system 206 adjusts the rotation rate of the rotating sprinkler 901 such that the rotating sprinkler 901 rotates at a relatively quicker rate, therefore applying less or no water to the areas that do not correspond to the first portion 990 and/or the third portion 992. In this manner, the rotating sprinkler 901 effectively waters the first portion 990 and the third portion 992.

In another embodiment, the central control system 206 waters the second portion 991 by adjusting one or more of the elevation angle actuator 920, the spreader plate actuator 940, or the water flow actuator 960 such that the rotating sprinkler 901 projects water to areas corresponding to the second radial distance 997, such as, for example, the second portion 991. When the rotating sprinkler 901 is rotating through areas corresponding to the second portion 991, the rotating sprinkler 901 rotates at a relatively slow rate, therefore applying water to the second portion 991. When the rotating sprinkler 901 is rotating through areas not corresponding to the second portion 991, the central control system 206 adjusts the rotation rate of the rotating sprinkler 901 such that the rotating sprinkler 901 rotates at a relatively quicker rate, therefore applying less or no water to the areas that do not correspond to the second portion 991. In this manner, the rotating sprinkler 901 effectively waters the second portion 992.

FIG. 10A is a diagram of one embodiment of the sprinkler 1000 having a sprinkler head 1002, the elevation angle actuator 920, the spreader plate actuator 940, and a spreader plate 1010. The elevation angle actuator 920 and the spreader plate actuator 940 can be, for example, solenoids, stepper motors, switches, relays, valves, or the like. As shown in FIG. 10A, the sprinkler 1000 is configured to project water in a first direction 1005 at a first elevation angle and in a second direction 1015 at a second elevation angle. In one embodiment, water projected in the first direction 1005 waters areas corresponding to a first distance away from the sprinkler 1000. In another embodiment, water projected in the second direction 1015 waters areas corresponding to a second distance away from the sprinkler 1000. In other embodiments, water projected in a third direction (not shown) waters areas corresponding to a third distance away from the sprinkler 1000.

In FIG. 10A, when the elevation angle actuator 920 is at a first state (for example, active or inactive), water is projected from the sprinkler 1000 in the first direction 1005. In one embodiment, when the elevation angle actuator 920 is in a second state, water is projected from the sprinkler 1000 in the second direction 1015. In still another embodiment, when the elevation angle actuator 920 is in a third state, water is projected from the sprinkler 1000 in the third direction. As shown in FIG. 10A, the elevation angle actuator 920 controls the elevation angle by controlling the position of the sprinkler head 1002. When the sprinkler head 1002 is in a first position, the sprinkler head 1002 waters areas corresponding to a first distance away from the sprinkler 1000. In one embodiment, when the sprinkler head 1002 is in a first position, water is projected from the sprinkler 1000 in the first direction 1005. When the sprinkler head 1002 is in a second position, the sprinkler 1000 waters areas located a second distance away from the sprinkler 1000. In one embodiment, the when the sprinkler head 1002 is in the second position, water is projected from the sprinkler 1000 in the second direction 1015. In some embodiments, the sprinkler 1000 adjusts the position of the sprinkler head 1002 by adjusting the angle of the sprinkler head 1002 relative to sprinkler shaft 1070.

Still with reference to FIG. 10A, when the spreader plate actuator 940 is in a first state, the spreader plate 1010 is in a first position. When the spreader plate 1010 is in a first position, the sprinkler 1000 waters areas corresponding to a first distance away from the sprinkler 1000. In one embodiment, when the spreader plate 1010 is in a first position, the sprinkler 1000 projects water in the first direction 1005. When the spreader plate actuator 940 is in a second state, the spreader plate 1010 is in a second position and the sprinkler 1000 waters areas that correspond to a second distance away from the sprinkler 1000. In one embodiment, when the spreader plate 1010 is in the second position, water is projected from the sprinkler 1000 in the second direction 1015. In a further embodiment, the spreader plate actuator is in a third state, the spreader plate 1010 is in a second position, water is projected from the sprinkler 1000 is the third direction and the sprinkler 1000 waters areas that correspond to a third distance away from the sprinkler 1000.

FIG. 10B is a diagram of one embodiment of the sprinkler 1000 having a nozzle 1020, the elevation angle actuator 920 and the water flow actuator 960. The elevation angle actuator 920 and the water flow actuator 960 can be, for example, solenoids, stepper motors, switches, relays, valves, or the like. As shown in FIG. 10B, the sprinkler 1000 is configured to project water in a first direction 1025 at a first elevation angle and in a second direction 1035 at a second elevation angle. In one embodiment, water projected in the first direction 1025 waters areas located a first distance away from the sprinkler 1000. In another embodiment, water projected in the second direction 1035 waters areas corresponding to a second distance away from the sprinkler 1000. In yet another embodiment, water projected in the third direction waters areas corresponding to a third distance away from the sprinkler 1000.

In one embodiment, when the elevation angle actuator 920 is at a first state, the nozzle 1020 of the sprinkler 1000 is in a first position and water is projected from the sprinkler 1000 in the first direction 1025. In another embodiment, when the elevation angle actuator 920 is in a second state, the nozzle 1020 is in a second position and the sprinkler 1000 sprays water in the second direction 1035. When the elevation angle actuator 920 is in a third state, the nozzle 1020 is in a third position and the sprinkler 1000 sprays water in the third direction.

In other embodiments, when the water flow actuator 960 is in a first state, water flows out of the nozzle 1020 at a first setting and the sprinkler 1000 waters areas corresponding to a first distance away from the sprinkler 1000. In one embodiment, when the water flow actuator 960 is in the first state, water is projected from the sprinkler 1000 in the first direction 1025. In another embodiment, when the water flow actuator 960 is in a second state, water flows out of the nozzle 1020 at a second setting, and the sprinkler 1000 waters regions corresponding to a second distance away from the sprinkler 1000. In one embodiment, when the water flow actuator 960 is in the second setting, water is projected from the sprinkler 1000 in the second direction 1035. In an embodiment, when the water flow actuator 960 is in a third setting, water is projected from the sprinkler 1000 in the third direction and the sprinkler 1000 waters areas corresponding to a third distance away from the sprinkler 1000. The water flow actuator 960 can control various parameters of water flowing through the sprinkler 1000 such as, without limitation, volume, rate, velocity, pressure, etc.

Although the sprinkler 1000 in FIGS. 10A and 10B includes the elevation angle actuator 920, the spreader plate actuator 940, and the water flow actuator 960, the sprinkler 1000 can include two or more actuators to control each of the rate of rotation, the elevation angle of projected water, the position of the spreader plate or the parameters of flow of water. For example, the sprinkler 1000 can be configured to include two or more elevation angle actuators 920 to enable the sprinkler 1000 project water in more than two directions and/or elevation angles. In some embodiments, using two or more actuators to control each of the rate of rotation, the elevation of projection, the position of the spreader plate or the parameters of flow of water provides the sprinkler 1000 more than three states (for example, active, inactive, default or neutral) to control each of the rate of rotation, the elevation of projection, the position of the spreader plate or the parameters of flow of water, thereby enabling the sprinkler 1000 to water areas of the zone corresponding to a wide array of distances. In some embodiments, the sprinkler 1000 includes two or more actuators arranged in series.

In other embodiments, the sprinkler 1000 in FIGS. 10A and 10b includes manual settings to control each of the rate of rotation, the elevation angle of projection, the position of the spreader plate or the parameters of flow of water. For example, when users set the rate of rotation at a first setting, the sprinkler 1000 waters areas corresponding to a first radial distance. When users set the rate of rotation at a second setting, the sprinkler 1000 waters areas corresponding to a second radial distance. In another embodiment, when users adjust the position of the spreader plate 1010 to a first position, the sprinkler 1000 waters areas corresponding to a first radial distance and when users adjust the position of the spreader plate 1010 to a second position, the sprinkler 1000 waters areas corresponding to a second radial distance. In one arrangement, when users set the flow of water going through the sprinkler 1000 to a first setting (for example, a first volume), the sprinkler 1000 waters areas corresponding to a first radial distance. When users set the flow of water going through the sprinkler 1000 to a second setting (for example, a first volume), the sprinkler 1000 waters areas corresponding to a second radial distance.

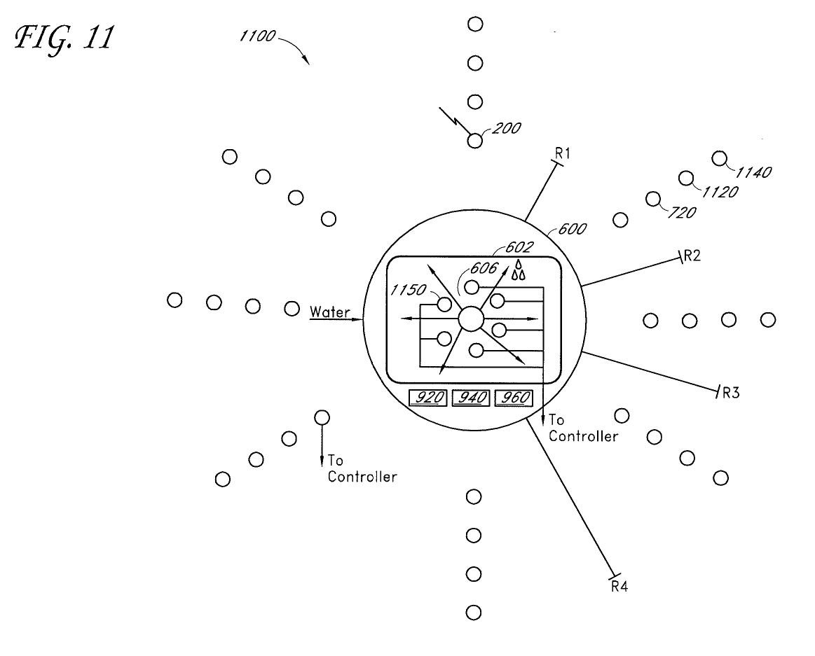

FIG. 11 illustrates an embodiment of a non-rotating sprinkler 1100. The sprinkler 1100 includes the sprinkler head 602, and at least one port actuator 1150. In some embodiments, the port actuator 1150 includes two states, such as, for example, active and inactive states. In other embodiments, the port actuator 1150 includes three states, such as, for example, active, inactive, and neutral states. In still other embodiments, the port actuator 1150 includes more than three states, such as, for example, when the port actuator 1150 includes two or more solenoids. In one embodiment, each port actuator 1150 controls a port 606 associated with the port actuator 1150. In another embodiment, the actuators 604 and their associated ports 606 form a ring around the perimeter of the sprinkler head 602.

The water supply 204 through the activated water supply valve 202 supplies water to the sprinkler 1100. When the port 606 is open, water flows through the port 606. In one embodiment, when the port actuator 1150 is active, the port 606 is open. In another embodiment, when the port actuator 1150 is active, the port 606 is closed. In another embodiment, when the port actuator 1150 is inactive, the port 606 is closed. In a yet further embodiment, when the port actuator 1150 is inactive, the port 606 is open.

The sprinkler 1100 of FIG. 11 further includes one or more moisture sensors associated with the sprinkler 1100, including the first level moisture sensors 200, the second level moisture sensors 720, third level moisture sensors 1120 and fourth level moisture sensors 1140. As previously mentioned, the first level moisture sensors 200, the second level moisture sensors 720, the third level moisture sensors 1120 and the fourth level moisture sensors 1140 collect moisture data and provide the moisture data to the sprinkler 1100 or to the central control system 206 using either electrical connections or wireless transmission systems, or a combination of electrical connections and wireless transmission systems, as described above.

The non-rotating sprinkler 1100 further includes the elevation angle actuator 920, the spreader plate actuator 940, and the water flow actuator 960. The sprinkler 1100 can be configured to use the elevation angle actuator 920, the spreader plate actuator 940, or the water flow actuator 960 to change the distances where the sprinkler 1100 applies water to areas associated with the ports 606. In some embodiments, the sprinkler 1100 is configured to use the port actuator 1150 to adjust the areas where the sprinkler 1100 applies water.

Based on the moisture data, the central control system 206 sends state information to the sprinkler 1100 to control the actuators 604. The actuators 604 open the ports 606 as determined by the state information. The sprinkler 1100 waters the area associated with the open ports 606. In some embodiments, the sprinkler 1100 is configured to adjust the distances at which the sprinkler 1100 projects water by adjusting the size of the port 606 that is opened by the port actuator 1150. In one embodiment, when the port actuator 1150 is in a first state, the port 606 is open to a first position and the sprinkler 1100 waters areas corresponding to a first portion. In another embodiment, when the port actuator 1150 is in a second state, the port 606 is open to a second position and the sprinkler 1100 waters areas corresponding to a second portion. In some embodiments, when the port actuator 1150 is in a third state, the port 606 is open to a third position and the sprinkler 1100 waters areas corresponding to a third portion. In still another embodiment, when the port actuator 1150 is in a third state, the port 606 is closed.

Also based on the moisture data, the central control system 206 sends state information to the sprinkler 1100 to control the elevation angle actuator 920, the spreader plate actuator 940, and the water flow actuator 960, thereby controlling the distance at which the sprinkler 1100 waters the area associated with the open ports 606. In one embodiment, the central control system 206 sends information to the sprinkler 1100 to control the elevation angle actuator 920. The sprinkler 1100 uses the elevation angle actuator 920 to control the distances at which the sprinkler 1100 waters the area associated with the open ports 606. In one embodiment, the elevation angle actuator 920 controls the distance at which the sprinkler 1100 projects water by adjusting the angle of the sprinkler head 602. In another embodiment, the elevation angle actuator 920 changes the distance at which the sprinkler 1100 projects water by changing the angle of the nozzle (not shown).

In one embodiment, when the elevation angle actuator 920 is active, the sprinkler 1100 waters areas at a first location. In another embodiment, when the elevation angle actuator 920 is active, the sprinkler 1100 waters the area at a second location. In one embodiment, when the elevation angle actuator 920 is inactive, the sprinkler 1100 waters areas in the first location. In another embodiment, when the elevation angle actuator 920 is inactive, the sprinkler 1100 waters areas in the second location. In some embodiments, the first location is located at a radial distance different from the second location.

The central control system 206, based on the moisture data, also sends state information to the sprinkler 1100 to control the spreader plate actuator 940. The sprinkler 1100 uses the spreader plate actuator 940 to determine at which distance the sprinkler 1100 waters the area associated with the open ports 606. In one embodiment, when the spreader plate actuator 940 is in a first state, the sprinkler 1100 waters areas corresponding to a first radial distance away from the sprinkler 1100. In another embodiment, when the spreader plate actuator 600 is in a second state, the sprinkler 1100 waters the areas corresponding to a second radial distance away from the sprinkler 1100.

The spreader plate actuator 940 can control the position of the spreader plate in several manners. In one embodiment, the spreader plate actuator 940 changes the distance at which the sprinkler 1100 projects water by moving the spreader plate in the vertical direction. In another embodiment, the spreader plate actuator 940 changes the distance at which the sprinkler 1100 projects water by moving the spreader plate in the horizontal direction. In still other embodiments, the spreader plate actuator 940 changes the distance at which the sprinkler 1100 projects water by moving the spreader plate in both the vertical and the horizontal directions. In still further embodiments, the spreader plate actuator 940 changes the distance at which the sprinkler 1100 projects water by changing the angle of the spreader plate, such as, for example, relative to the sprinkler head 602.

In one embodiment, when the spreader plate actuator 940 is active, the sprinkler 1100 waters the area a first location. In another embodiment, when the spreader plate actuator 940 is active, the sprinkler 1100 waters the area a second location. In one embodiment, when the spreader plate actuator 940 is inactive, the sprinkler 1100 waters the area at a first location. In another embodiment, when the spreader plate actuator 940 is inactive, the sprinkler 1100 waters the area at a second location. In some embodiments, the first location and the second location are substantially apart from each other such that the sprinkler 1100 has to adjust the distances at which the sprinkler 1100 applier water to effectively water the first location and the second location.

Still based on the moisture data, the central control system 206 sends state information to the sprinkler 1100 to control the water flow actuator 960. The sprinkler 1100 uses the water flow actuator 960 to determine at which distance the sprinkler 1100 waters the area associated with the open ports 606. In one embodiment, when the water flow actuator 960 is in a first state, the sprinkler 100 waters areas corresponding to a first radial distance away from the sprinkler 1100. In another embodiment, when the water flow actuator 960 is in a second state, the sprinkler 1100 waters the areas corresponding to a second radial distance away from the sprinkler 1100. In some embodiments, the first radial distance and the second radial distance are substantially apart from each other such that the sprinkler 100 has to adjust the distances at which the sprinkler 1100 applier water to effectively water areas corresponding to the first radial distance and the second radial distance.

The water flow actuator 960 can also be configured to change the distance at which the sprinkler 1100 projects water by changing flow parameters associated with the water flowing through the sprinkler 1100. In one embodiment, the water flow actuator 960 changes the volume of water flowing through the sprinkler 1100. In another embodiment, the water flow actuator 960 controls the distance at which the sprinkler 100 projects water by adjusting the rate at which water flows through the sprinkler 1100. In a further embodiment, the water flow actuator 960 controls the velocity of water flowing through the sprinkler 1100 to adjust where the sprinkler 100 applies water.

In one embodiment, when the water flow actuator 960 is active, the sprinkler 1100 waters areas located corresponding to a first position. In another embodiment, when the water flow actuator 960 is active, the sprinkler 100 waters areas located surrounding a second position. In one embodiment, when the water flow actuator 960 is inactive, the sprinkler 100 waters areas associated to the first position. In another embodiment, when the water flow actuator 960 is inactive, the sprinkler 1100 waters areas associated with the second position. In some embodiments, the first position is located at a radial distance different from the second position. In other embodiments, the first position and the second position are located substantially apart from each other such that the sprinkler 1100 adjusts the distances the sprinkler 1100 projects water to effectively water the first and the second positions.

Still with reference to FIG. 11, the sprinkler 1100 can be configured to use a combination of two or more of the elevation angle actuator 920, the spreader plate actuator 940, and/or the water flow actuator 960 to control the areas watered by the sprinkler 1100. For example, in one embodiment, the sprinkler 1100 uses two of the elevation angle actuator 920, the spreader plate actuator 940, and/or the water flow actuator 960 to adjust where the sprinkler 1100 applies water, including the distance at which the sprinkler 1100 projects water. In other embodiments, the sprinkler 1100 uses all of the elevation angle actuator 920, the spreader plate actuator 940, and/or the water flow actuator 960 to control where the sprinkler 1100 applies water, including controlling the distances at which the sprinkler 1100 projects water.

With continued reference to FIG. 11, the sprinkler 1100 in some embodiments can use a combination of the elevation angle actuator 920, the spreader plate actuator 940, and/or the water flow actuator 960 to compound the distance at which the sprinkler 1100 applies water to the area associated with the sprinkler 1100. For example, in one embodiment, when all of the elevation angle actuator 920, the spreader plate actuator 940, and/or the water flow actuator 960 are at a first state (for example, inactive) the sprinkler 1100 waters areas applies at or near a first radial distance R1. In another embodiment, when one of the elevation angle actuator 920, the spreader plate actuator 940, and/or the water flow actuator 960 is at a second state (for example, active) and the other remaining actuators remain at the first state, the sprinkler 100 waters areas near a second radial distance R2. In other embodiments, when two of the elevation angle actuator 920, the spreader plate actuator 940, and/or the water flow actuator 960 are at the first state, the sprinkler 1100 waters areas at or near a third radial distance R3. In still other embodiments, when all of the elevation angle actuator 920, the spreader plate actuator 940, and/or the water flow actuator 960 are at the first state, the sprinkler 1100 waters areas corresponding to a fourth radial distance R4.

In another embodiment, the sprinkler 1100, using the computer 304, controls the state of the actuators 604 based on the moisture data. The sprinkler 1100 activates the actuators 604 to open the ports 606, which waters the areas associated with the open ports 606. Using the computer 304, the sprinkler 1100 also activates one or more of the elevation angle actuator 920, the spreader plate actuator 940, and/or the water flow actuator 960 to change the distance at which the sprinkler 1100 waters the areas associated with the ports 606.

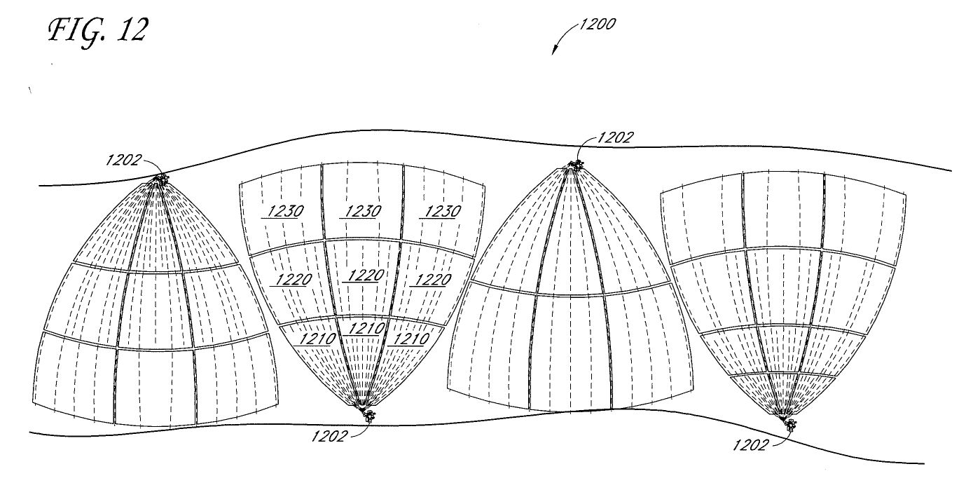

FIG. 12 illustrates one embodiment of a sprinkler system 1200 wherein the sprinklers 1202 apply water to a watering zone, including relatively large watering zones, such as, for example, golf courses, recreational parks, and farms. The watering zone in FIG. 12 shows subsections of the watering zone to be watered, including first regions 1210, second regions 1220, and third regions 1230.

In one embodiment, the first regions 1210, the second regions 1220, and the third regions 1230 correspond to areas that are substantially apart. The area corresponding to the center of the third regions 1230 can be located tens or hundreds of meters away from the area corresponding to the center of the second regions 1220. Similarly, the area corresponding to the center of the second regions 1220 can be located tens or hundreds of meters away from the area corresponding to the center of the first regions 1210. To effectively water the first regions 1210, the second regions 1220, and the third regions 1230, a relatively large number of sprinklers normally would have to be placed throughout the watering zone, sometimes including in the first regions 1210, the second regions 1220, and the third regions 1230.

As shown in FIG. 12, the sprinklers 1202 can be configured to project water to relatively large distances and, therefore, are able to water relatively large watering zones. The sprinklers 1202 are configured to apply water to different subsections of the watering zone, including first regions 1210, second regions 1220, and third regions 1230 of the watering zone. As mentioned herein, adjusting the distances at which the sprinklers 1202 apply water enables the sprinkler 1202 to effectively water the first regions 1210, the second regions 1220, and/or the third regions 1230. Because the sprinklers 1202 can project water to larger distances, and because the sprinklers 1202 can adjust the distances at which the sprinklers 1202 apply water, the sprinkler system 1200 can use a relatively small number of sprinklers 1202 to effectively water the watering zone, including the first regions 1210, the second regions 1220, and/or the third regions 1230.

Still with reference to FIG. 12, the sprinklers 1202 can be positioned strategically at alternating ends of the watering zone, thereby providing a relatively low number of the sprinklers 1202 to effectively water relatively large portions of the watering zone, including the first regions 1210, the second regions 1220, and/or the third regions 1230.

The ability of a relatively small number of the sprinklers 1202 to apply water to the different regions of the watering zone covering large areas reduces the overall number of sprinklers 1202 used in the sprinkler system 1200. Reducing the number of sprinklers 1202 used in the sprinkler system 1200 can reduce the installation, as well as maintenance, cost of the sprinkler system 1202.

In some embodiments, the sprinkler 1202 is a rotating sprinkler, such as, for example, the rotating sprinkler 901 of FIG. 9. A rotating sprinkler 1202 rotates in an arc or in portions of an arc to apply water to, for example, each of the three sections of the first regions 1210. In other embodiments, the sprinkler 1202 is a non-rotating sprinkler, such as, for example, the non-rotating sprinkler 1100 of FIG. 11. The non-rotating sprinkler 1202 can be configured to include multiple ports associated with, for example, each of the three sections of the first regions 1210. As described in connection with FIG. 11, the non-rotating sprinkler 1202 opens the port associated with a particular section of the first region 1210 to water the section.

As described herein, the sprinklers 1202, whether rotating or non-rotating, can adjust the distances at which they apply water by adjusting one or more of the water elevation angle of water that is projected from the sprinklers 1202, the position of a spreader plate, and/or the flow parameters of the water that is projected from the sprinklers 1202 (for example, volume, velocity, rate, pressure, etc.) to water areas of the watering zone, such as, for example, the third regions 1230.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

What is claimed is:

1. A sprinkler system comprising:
a sprinkler head configured to water a zone comprising first and second portions;
wherein the sprinkler head comprises an adjustable spray pattern, and wherein the first portion of the area corresponds to a first distance, and wherein the second portion of the area corresponds to a second distance;
a first moisture sensor provided in the first portion, wherein the first moisture sensor is configured to collect a first moisture data;
a second moisture sensor provided in the second portion, and wherein the second moisture sensor is configured to collect a second moisture data; and
a controller configured to obtain the moisture data and control the adjustable spray pattern based on the first moisture data and the second moisture data, wherein the controller controls the adjustable spray pattern such that water is applied in the first portion of the zone if the first moisture data indicates that the first portion of the zone needs water, and wherein the controller controls the adjustable spray pattern such that water is applied in the second portion of the zone if the second moisture data indicates that the second portion of the zone needs water.

2. The sprinkler system of claim 1, wherein the controller uses one or more actuators to control the adjustable spray pattern.

3. The sprinkler system of claim 1, wherein the controller adjusts the position of the sprinkler head to control the adjustable spray pattern.

4. The sprinkler system of claim 1, wherein the controller adjusts the angle of the sprinkler head to control the adjustable spray pattern.

5. The sprinkler system of claim 1, wherein the sprinkler head comprises a nozzle.

6. The sprinkler system of claim 5, wherein the controller adjusts the position of the nozzle to control the adjustable spray pattern.

7. The sprinkler system of claim 6, wherein the controller adjusts the angle of the nozzle to control the adjustable spray pattern.

8. The sprinkler system of claim 1, wherein the sprinkler head comprises a spreader plate.

9. The sprinkler system of claim 8, wherein the controller adjusts the position of the spreader plate to control the adjustable spray pattern.

10. The sprinkler system of claim 1, wherein the controller adjusts the flow of water going through the sprinkler head to control the adjustable spray pattern.

11. The sprinkler system of claim 10, wherein the controller adjusts the flow of water going through the sprinkler head by adjusting volume of the water.

12. The sprinkler system of claim 10, wherein the controller adjusts the flow of water going through the sprinkler head by adjusting rate of the water.

13. A method of watering comprising:
obtaining moisture data from a first moisture sensor associated with a rotating sprinkler head;
obtaining moisture data from a second moisture sensor associated with a rotating sprinkler head; and
automatically configuring an adjustable spray pattern based on the moisture data, wherein automatically configuring the adjustable spray pattern comprises watering a first portion of the zone if the moisture data indicates the first portion of the zone to be less moist, and wherein automatically configuring the adjustable spray pattern comprises watering a second portion of the zone if the moisture data indicates the second portion of the zone to be less moist, wherein the first portion of the zone corresponds to a radial distance substantially apart from the second portion of the zone.

14. The method of claim 13, wherein automatically configuring the adjustable spray pattern comprises adjusting the angle of the rotating sprinkler head.

15. The method of claim 13, wherein automatically configuring the adjustable spray pattern comprises adjusting the angle of a nozzle associated with the rotating sprinkler head.

16. The method of claim 13, wherein automatically configuring the adjustable spray pattern comprises adjusting the position of a sprinkler plate associated with the rotating sprinkler head.

17. The method of claim 13, wherein automatically configuring the adjustable spray pattern comprises adjusting the flow of water going through the sprinkler head.

18. The method of claim 17, wherein adjusting the flow of water going through the sprinkler head comprises adjusting the water volume.

19. A sprinkler system comprising:
means for obtaining moisture data from a first moisture sensor associated with a rotating sprinkler head;
means for obtaining moisture data from a second moisture sensor associated with a rotating sprinkler head; and
means for automatically configuring an adjustable spray pattern based on the moisture data, wherein automatically configuring the adjustable spray pattern comprises watering a first portion of the zone if the moisture data indicates the first portion of the zone to be less moist, and wherein automatically configuring the adjustable spray pattern comprises watering a second portion of the zone if the moisture data indicates the second portion of the zone to be less moist, wherein the first portion of the zone is located at a different distance from the second portion of the zone.

20. A sprinkler system comprising:
a rotating sprinkler head comprising an adjustable spray pattern;
a zone to be watered by the rotating sprinkler head, the zone at least comprising a first region and a second region, wherein the first area and the second area are located at a different distances from the sprinkler head;
one or more moisture sensors provided in the zone, wherein the one or more moisture sensors are configured to collect moisture data; and
a controller configured to obtain the moisture data and configure the adjustable spray pattern based on the moisture data, wherein the controller adjusts the adjustable spray pattern to apply water to the first area and/or the second area of the zone as indicated by the one or more moisture sensors to need watering.

21. The sprinkler system of claim 20, wherein the controller adjusts the rotating sprinkler head angle to configure the adjustable spray pattern.

22. The sprinkler system of claim 20, wherein a rotating sprinkler head comprises a nozzle.

23. The sprinkler system of claim 22, wherein the controller adjusts the nozzle angle to control the adjustable spray pattern.

24. The sprinkler system of claim 20, wherein the rotating sprinkler head comprises a spreader plate.

25. The sprinkler system of claim 24, wherein the controller adjusts the position of the spreader plate to control the adjustable spray pattern.

26. The sprinkler system of claim 20, wherein the controller adjusts the flow of water going through the rotating sprinkler head to control the adjustable spray pattern.

27. The sprinkler system of claim 26, wherein the controller adjusts the flow of water going through the sprinkler head by adjusting volume of the water.

28. The sprinkler system of claim 26, wherein the controller adjusts the flow of water going through the sprinkler head by adjusting rate of the water.

29. A sprinkler system comprising:
a sprinkler comprising a sprinkler head, a spreader plate and a nozzle;
one or more moisture sensors that measure moisture in a zone to be watered by the sprinkler head, wherein the one or more moisture sensors are configured to provide moisture data related to the zone; and
a controller configured to obtain the moisture data and control the distances in the zone where the sprinkler applies water, wherein the controller adjusts one or more of the position of the sprinkler head, the position of the spreader plate, the position of the nozzle, or volume of water going through the sprinkler to control the distances in the zone where the sprinkler applies water.

30. The sprinkler system of claim 29, wherein the controller uses actuators to adjust one or more of the position of the sprinkler head, the position of the spreader plate, the position of the nozzle, or the volume of water going through the sprinkler.
